(19) United States
(12) Patent Application Publication
(10) Pub. No.: US 2005/0111935 A1
(43) Pub. Date: May 26, 2005

(54) Apparatus and method for improved wafer transport ambient

(76) Inventors: Hyeog-Ki Kim, Seoul (KR); Kun-Hyung Lee, Suwon-si (KR); Ok-Sun Lee, Suwon-si (KR); Ki-Doo Kim, Suwon-si (KR); Chang-Min Cho, Hwasung-gun (KR)

Correspondence Address: HARNESS, DICKEY & PIERCE, P.L.C., P.O. BOX 8910, RESTON, VA, 20195, US

(21) Appl. No.: 10/857,951

(22) Filed: Jun. 2, 2004

(30) Foreign Application Priority Data
Nov. 12, 2003 (KR) 2003-79859

(51) Int. Cl. B65G 65/34

(52) U.S. Cl. 414/217

(57) ABSTRACT

An improved wafer transfer apparatus is provided that allows the ambient atmosphere within a modified front open unified pod (“FOUP”) while the FOUP is positioned on a loading stage provided on an equipment front end module (“EFEM”). In particular, the wafer transfer apparatus includes both an injection assembly and an exhaust assembly that will be engaged when the door of the FOUP is docked to a door holder provided on the EFEM. The injection assembly may include a mass flow controller (“MFC”) for controlling the injection of purge gas(es) into the container. Similarly, the exhaust assembly may include a MFC for controlling the removal of fluid from the container. While the door is docked to the door holder, inert or less reactive gases may be introduced into the container, thereby reducing the likelihood of oxidation or contamination of the wafers therein.

### CROSS REFERENCE TO RELATED APPLICATIONS

This U.S. nonprovisional patent application claims priority under 35 U.S.C. § 119 from Korean Patent Application 2003-79859, which was filed on Nov. 12, 2003, the entire contents of which are hereby incorporated by reference.

### BACKGROUND OF THE INVENTION

1. Field of the Invention

The present invention relates to apparatus and method for transporting semiconductor substrates within a clean room and delivering wafers to and receiving wafers from automated process equipment and, more particularly, to an apparatus including a load port for opening/closing a door provided on a container in which semiconductor substrates are loaded and a method for filling the inside of the container with a selected gas or gas mixture to improve the ambient environment to which the wafers are exposed during transport and storage.

2. Discussion of the Related Art

Conventional semiconductor manufacturing processes are performed in large clean rooms and commonly use open wafer containers for storing and transferring wafers within the clean room. In recent years, in an effort to reduce the cost of maintaining a large clean room environment, manufacturing facilities have been developed in which a high degree of cleanliness is required only selected areas such as within the process equipment and associated wafer handling operations, while a somewhat lower degree of cleanliness is acceptable in the other parts of the facilities. Sealed wafer containers are typically used to shield the wafers from atmospheric foreign substances or chemical contamination when transferring wafers through those areas maintained at a low degree of cleanliness. A typical example of a sealed wafer container is a front open unified pod (hereinafter referred to as “FOUP”).

As the diameter of the wafers continues to increase, such as from 200 mm to 300 mm, semiconductor chips are increasing manufactured using automated systems, in part simply due to the weight of the wafers and their container. In order to automate the semiconductor manufacturing process and operate in the clean room environment, an equipment front end module (hereinafter referred to as “EFEM”) is used. The EFEM is connected to a process apparatus for transferring wafers from a FOUP to the process apparatus or vice versa.

A load port used in such a EFEM facility is disclosed in U.S. Pat. No. 6,473,996. When an FOUP is placed on a station on the load port, the FOUP door is opened by a door opener and wafers are removed from the FOUP for transfer to the process equipment. After the processing has been completed, the processed wafers are then returned to the FOUP, and the FOUP door is closed to seal the wafers within the FOUP before they are removed from the EFEM station and protect them from contamination in the outside environment. Although air flowing into the EFEM is filtered, it will still contain molecular and gaseous contaminants such as oxygen, water and ozone. Thus, these contaminants will be present in the sealed FOUP and may oxidize a wafer surface or bind to the wafer surface in a manner that can interfere with subsequent processing or otherwise lower the final yield of good semiconductor products.

### SUMMARY OF THE INVENTION

Exemplary embodiments of the present invention are directed to an apparatus and a method for suppressing formation of a native oxide layer or other defects on a wafer resulting from contaminants within the FOUP. In an exemplary embodiment, the apparatus includes a load port and a container for receiving semiconductor substrates. The container has a door in which at least one inflow hole or inlet port is formed. The load port has a station on which the container may be positioned and a door opener for opening/closing the door. The door opener includes a door holder that may be connected to the door when the container is opened and closed. An injection assembly is disposed on or within the door holder. The injection assembly injects gas through the inflow hole into the container to fill the inside of the container with the gas while the door is connected or docked to the door holder.

The injection assembly includes an injection port formed and positioned to cooperate with the inflow hole when the door is docked or connected to the door holder. The injection assembly also includes a supply pipe connected to the injection port for supplying the gas to the injection port and may include a mass flow controller installed in the supply pipe. The injection port may also be configured to inject the gas or cause the gas to flow in a direction generally parallel to the semiconductor substrates loaded in the container.

A filter for preventing or reducing the introduction of external particles into the container and an inflow hole open/close assembly for opening/closing the inflow hole may be inserted into the inflow hole. The inflow hole open/close assembly includes a fixture that is coupled to the flow hole and protrudes inwardly toward the inflow hole, an isolation plate for opening/closing a flow path through the fixture, and an elastic body connected to the isolation plate an arranged to apply force to the isolation plate tending to maintain a closed position. A passage for the gas may be provided at the center of the fixture. The isolation plate may be moved within the fixture by the pressure of the gas supplied from the injection part.

An outflow hole is formed at the door, and an exhaust assembly is provided at the door holder to provide an exhaust path for fluid exiting the container. The gas in the container may be removed through the outflow hole and the exhaust assembly while the door is docked with the door holder. The exhaust assembly includes an exhaust port that is a hole formed at the door holder, an exhaust pipe connected to the exhaust port, and a pump or other vacuum source connected to the exhaust pipe.

An outflow hole open/close assembly for opening/closing the outflow hole is provided adjacent the outflow hole. The outflow hole open/close assembly includes a protrusion plate that is connected to the outflow hole and protrudes inwardly toward the outflow hole, an isolation plate for opening/closing a moving plate of the protrusion plate, and an elastic body connected to the isolation plate for applying a force tending to maintain the isolation plate in a closed position. An air passage may be formed through the center of the protrusion plate when the isolation plate is separated from the protrusion plate by a vacuum applied by the pump or pressure within the container.

The injection port may be formed at one side of the door holder and the exhaust port is formed in another region offset from the injection port. The injection port may comprise a plurality of injection ports disposed at different heights or in a first pattern. A door fixing part may be provided for fixing and maintaining the orientation of door and the door holder while the gas is injected into and/or evacuated from the container. The door fixing part may include vacuum holes formed on the face of the door and/or the door holder through which a vacuum may be applied to hold the relative position of the door and door holder.

In an exemplary embodiment of the present invention, a substrate processing apparatus includes a container that receives semiconductor substrates and has a door and a handling system that allows the substrates to be transferred between the container and a processing apparatus and has a load port that includes a station on which the container may be positioned. At least one inflow hole and at least one outflow hole are formed through the container door. The load port includes a door holder that provides an injection port for injecting nitrogen gas and/or another inert gas into the container and an exhaust port for exhausting fluid from the container are engaged when the door holder is docked with the door. The nitrogen gas or inert gas injected from the injection port enters the container through the inflow hole of the door while fluid within the container is exhausted through the outflow hole of the door and the exhaust port.

In an exemplary embodiment of the present invention, a substrate processing method includes docking the door of an empty container arranged on a load port with a door holder separating the door from the container, transferring substrates into the container, resetting the door on the container, and injecting gas into the container through the inflow hole(s) formed in the door to fill the container with a non-reactive gas.

The step of filling the container with the gas may include both injecting the gas into the container from the injection port through the inflow hole and simultaneously exhausting fluid from the container through an outflow hole formed at the door and a second step of closing the outflow hole and injecting additional gas into the container from the injection part through the inflow hole to fill the inside of the container with the gas.

### BRIEF DESCRIPTION OF THE DRAWINGS

The features and advantages of the present invention are described with reference to exemplary embodiments in association with the attached drawings in which similar reference numerals are used to indicate like or corresponding elements and in which:

FIG. 1 is a cross-sectional view of a substrate treating apparatus according to an exemplary embodiment of the present invention;

FIG. 2 is a perspective view of an FOUP shown in FIG. 1;

FIG. 3 is a perspective view of a load port shown in FIG. 1;

FIG. 4 is a front view of an FOUP door;

FIG. 5 is a schematic diagram of a door opener;

FIG. 6 is a front view of a door holder at which a vacuum hole is formed;

FIG. 7 is a cross-sectional view of a portion where an inflow hole is formed at the FOUP door;

FIG. 8 and FIG. 9 are cross-sectional views showing the states that the inflow hole of the FOUP door is opened and closed, respectively;

FIG. 10 is a cross-sectional view of a portion where an outflow hole is formed at the FOUP door;

FIG. 11 and FIG. 12 are cross-sectional views showing a flow path of gas in the FOUP, respectively;

FIG. 13 is a flowchart of a substrate treating method according to an exemplary embodiment of the present invention;

FIG. 14 through FIG. 16 are cross-sectional views showing the steps of filling the inside of the FOUP with gas; and

FIG. 17 is a cross-sectional view showing an example that the substrate treating apparatus according to the present invention is connected to a cleaning facility.

These drawings have been provided to assist in the understanding of the exemplary embodiments of the invention as described in more detail below and should not be construed as unduly limiting the invention. In particular, the relative spacing, positioning, sizing and dimensions of the various elements illustrated in the drawings are not drawn to scale and may have been exaggerated, reduced or otherwise modified for the purpose of improved clarity. Those of ordinary skill in the art will also appreciate that certain alternative fixtures and mechanisms that may be commonly utilized in the operation of FOUP and EFEM structures, have been omitted simply to improve the clarity and reduce the number of drawings.

### DETAILED DESCRIPTION OF EXEMPLARY EMBODIMENTS

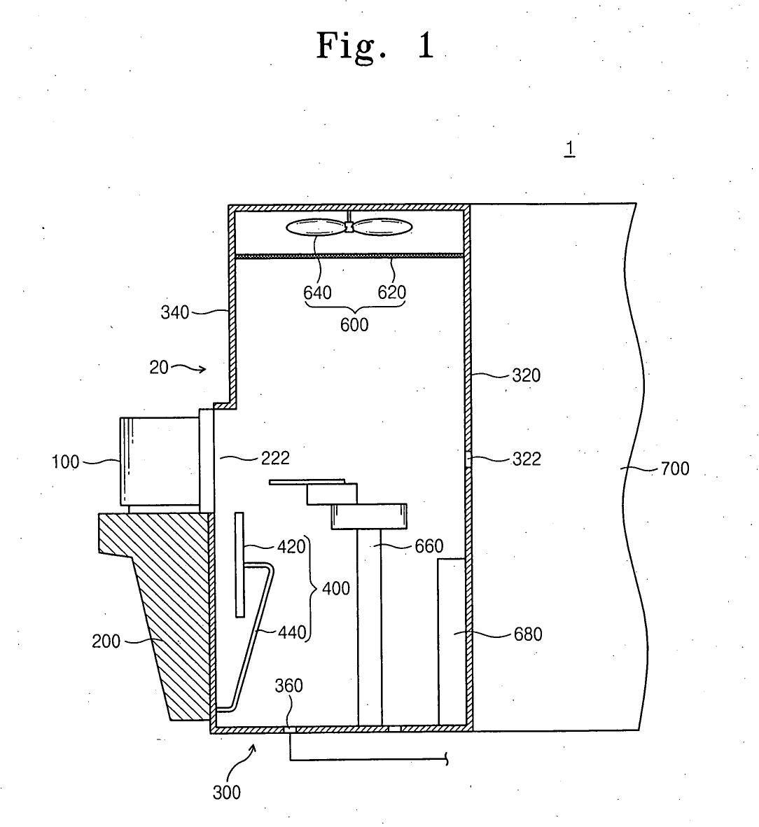

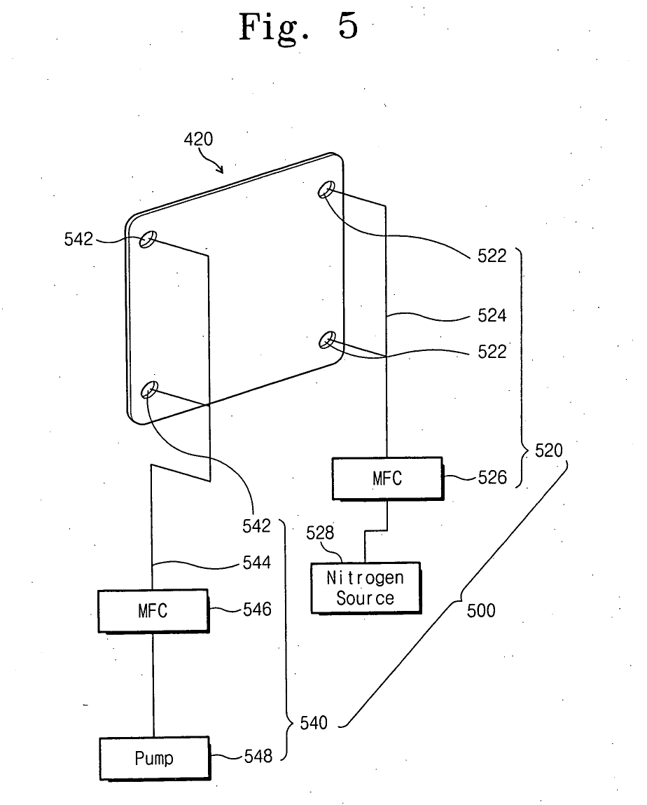

As illustrated in FIG. 1, a substrate treating or processing device 1 includes a container 100, a wafer handling system 20, and a purge part (500 of FIG. 5). The container 100 is a receptacle configured for receiving semiconductor substrates such as silicon wafers and will typically be a front open unified pod (hereinafter referred to as “FOUP”). The FOUP is a sealable wafer carrier used for shielding wafers from atmospheric and/or chemical contamination while transferring wafers between processing equipment and or storage areas.

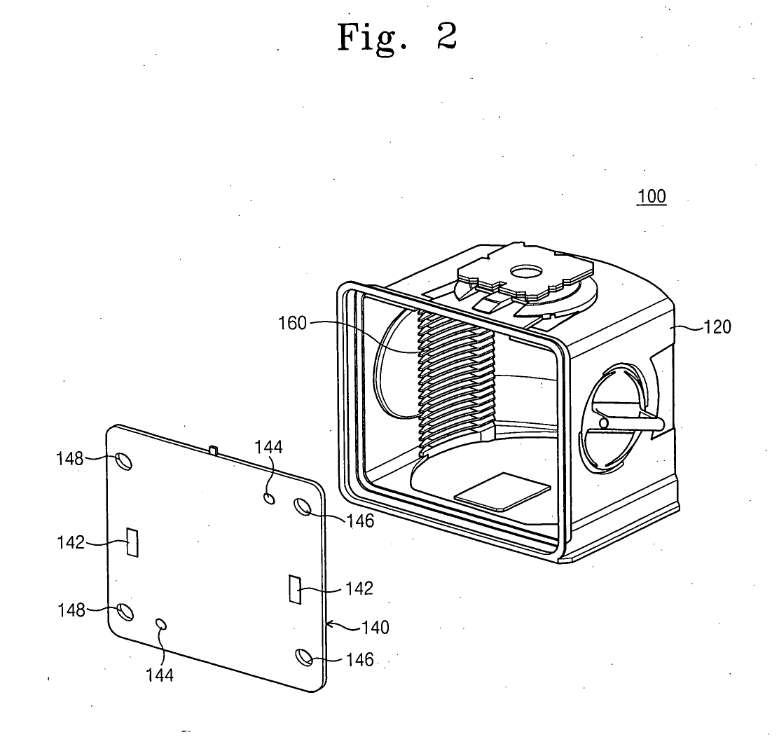

As illustrated in FIG. 2, the FOUP 100 may include a front-opening body 120 and a door 140 for opening/closing the front of the body 120. Parallel slots 160 are typically formed on the inner walls of the body 120 for supporting and separating wafers within the FOUP. The slots 160 may be substantially perpendicular to a plane defined by the door 140.

The wafer handling system 20 can be used to transfer wafers from the FOUP 100 to the process equipment or process apparatus 700 or vice versa. The wafer handling system 20 may include a housing 300, a load port 200, a cleaning part 600, and one or more transfer robots 660. The process apparatus 700 may be, for example, a chemical vapor deposition (CVD) apparatus, a dry etch apparatus, a thermal furnace, a developing apparatus or a cleaning apparatus. The housing 300 will typically include a carry-in or pass-through port 322 formed in a rear wall for transferring a wafer out of the housing and into and out of process apparatus 700 and another opening formed in the front wall 340 for transferring the wafers into and out of the FOUP 100.

The cleaning part 600 may be disposed in an upper portion in the housing 300 so as to maintain the inside of the housing 300 at the desired level of cleanliness. The cleaning part 600 may include a fan 640 and a filter 620. The fan 640 will typically move air downwardly through the housing 300 in a laminar flow with the filter 620 removing particles from the air before it enters the housing. An exhaust port 360 for exhausting the air may be provided at a bottom of the housing 300. The air may be naturally exhausted or forcibly exhausted using a pump or a blower (not shown). The transfer robot 660, used for extracting wafers from and returning wafers to the FOUP 100 and moving the wafers into and out of to the process apparatus 700 and may be controlled by a controller 680.

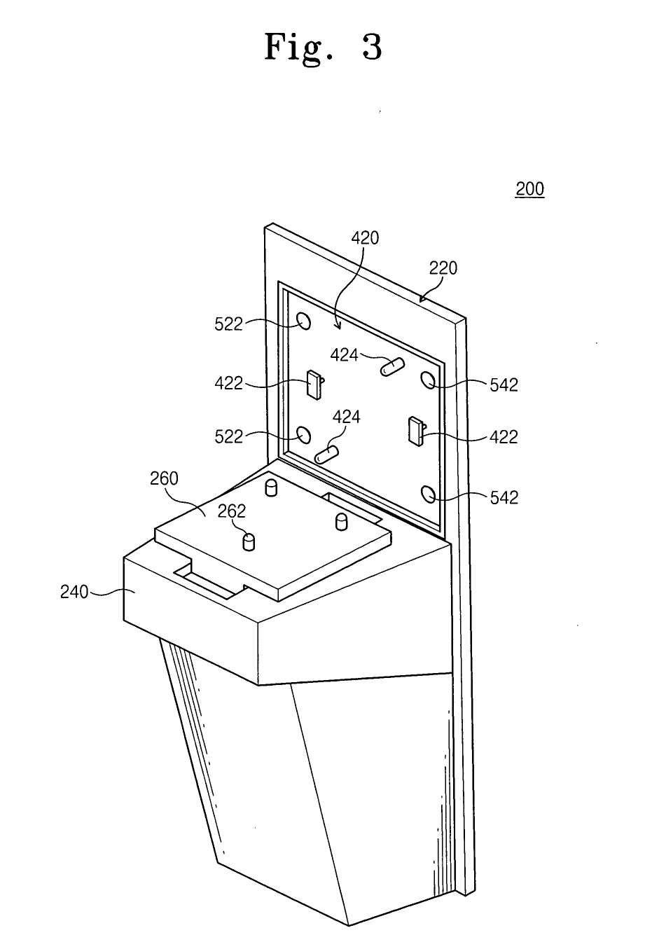

As illustrated in FIG. 3, the load port 200 may include a substantially vertical frame 220, a pedestal 240, a station 260, and a door opener (400 of FIG. 1). The vertical frame 220 can be inserted into an opening provided in the front wall 340 to seal the inside of the housing 300 from the outside environment. The pedestal 240 is coupled to a lateral side of the vertical frame 220. A through-hole (222 of FIG. 1) may be positioned in the vertical frame 220 to accommodate the door 140 when a FOUP 100 is placed on the pedestal 240. A station 260 is provided on the pedestal 240 for receiving the FOUP 100 and may include plurality of kinematic pins 262. When the FOUP 100 is placed on the station 260, the kinematic pins 262 are inserted into corresponding grooves or recesses (not shown) provided on the bottom of the FOUP 100 positioned on the station 260.

The door opener 400 can then be employed to open and close the door 140 of the FOUP 100 placed on the station 260. As illustrated the door opener 400 may include a door holder 420, an arm (440 of FIG. 1), and a driving mechanism (not shown). The door holder 420 can have the same general configuration as the through-hole 222 and may be inserted into the through-hole. The arm 440 will typically be connected to a rear side of the door holder 420 and driven by means of a driving mechanism mounted in the pedestal 240.

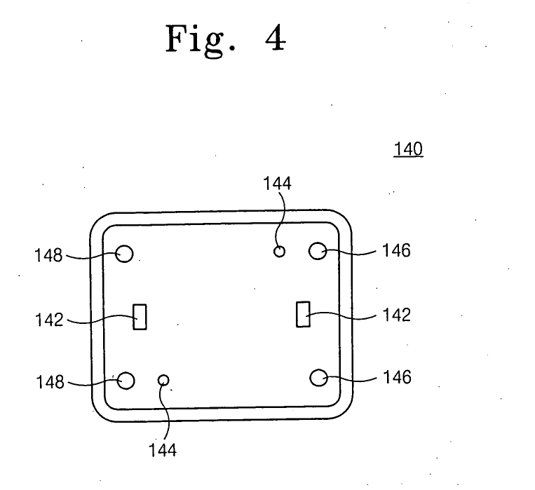

Latch keys 422 and registration pins 424 are provided on the door holder 420. The registration pins 424 aid in the precise positioning of the FOUP 100 to align the door 140 to the door holder 420 and the latch keys 422 that may be provided on both sides of the door holder 420. Referring to FIG. 4, registration pin holes 144 and latch key holes 142 are formed on the door 140. The registration pins 424 are inserted into the corresponding registration pin holes 144, and the latch keys 422 are inserted into the corresponding latch key holes 142.

When a FOUP 100 is placed on the station 260 and moved toward the door holder 420 exposed in the through-hole of the vertical frame 220, the registration pins 424 will slide into the registration pin holes 144 and determine the docking position between the door 140 and the door holder 420. The latch keys 422, which are simultaneously inserted into the corresponding latch key holes 142, are then rotated to dock or secure the door 140 to the door holder 420. The arm 440 will typically be connected to a rear side of the door holder 420 and may be moved in up-and-down and forward-and-backward directions by means of the driving part mounted in the pedestal 240. When the door 140 is opened, i.e., removed, from the FOUP 100, the arm 440 allows the door holder 420 to move backward a predetermined distance and then downward to a level typically below the level of the through-hole 222, separating the door 140 from the body 120 of the FOUP 100 and allowing access to the interior of the container. When wafers have been placed into the FOUP 100 by the transfer robot 660, the door holder 420 can reverse its movements and move upward and forward to connect or reset the door 140 on the body 120 of the FOUP.

Before the door 140 is closed, air present in the housing 300 may and typically will enter the FOUP 100. Although most particles may have been removed by the filter 620, the air in the housing 300 may still contain molecular contaminants such as oxygen, water and ozone. If the FOUP 100 is sealed while such molecular contaminants remain in the container, a native oxide layer or other defects may be formed on wafers loaded in the FOUP.

In order to prevent formation of the native oxide layer, the purge part 500 exhausts fluid from the FOUP 100 and fills the inside of the FOUP 100 with selected gas such as nitrogen, dry air, or an inert gas such as Ar or Xe. As illustrated in FIG. 5, the purge part 500 may include an injection part 520 for injecting nitrogen or other gas into the FOUP 100 and an exhaust part 540 for exhausting fluid from the FOUP. The injection part 520 and the exhaust part 540 are disposed at the door holder 420. The injection part 520 can include an injection port 522 and a supply pipe 524 while the exhaust part 540 can include an exhaust port 542 and an exhaust pipe 544.

The injection port 522 may be a hole formed at one edge portion of the door holder 420 while the exhaust port 542 may be a hole provided in another edge portion offset from the injection port. The injection port 522 may include a plurality of injection ports that may be positioned at different heights. Similarly, the exhaust port 542 may include a plurality of exhaust ports, with the number of exhaust ports tending to equal to that of the number injection ports, and may be positioned at the same or different heights than the injection ports. The positions of the injection port(s) 522 and the exhaust port(s) 542 may be arranged to enable the nitrogen or other purge gas to flow into the FOUP 100 under conditions that will produce turbulent flow and/or laminar flow within the container.

A supply pipe 524 may be connected between one or more nitrogen or other purge gas source 528 and the injection port 522 while an exhaust pipe 544 may be used to connect pump 548 to the exhaust port 542. Both the supply pipe 524 and the exhaust pipe 544 may be made of stainless steel, plastic or other suitable material(s) such that the door holder 420 may be repositioned by the arm 440 while maintaining the gas connections. Mass flow controllers (MFCs) 526 and 546 may be provided on the supply pipe 524 and the exhaust pipe 544, respectively. The MFC 526 may be used to control the amount of nitrogen or other gas(es) supplied to the injection port 522, and the MFC 546 may be used to control the amount of gas removed from the container. Optionally, pipes may be inserted into the injection port 522 and/or the exhaust port 542.

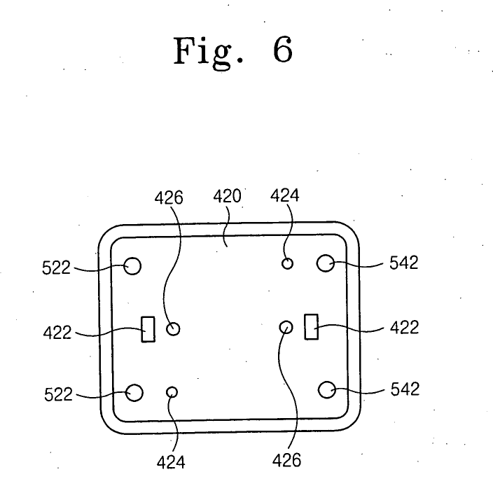

When the FOUP door 140 is separated from the FOUP body 120, the latch key 422 of the door holder 420 is inserted into the latch key hole 142 of the door 140, thereby docking the door 140 to the door holder 420. A door fixing part is provided to prevent the FOUP door 140 from swinging while the nitrogen or other purge gas is injected into the FOUP 100. The door fixing part may fix the FOUP door 140 to the door holder 420 by means of vacuum. As illustrated in FIG. 6, one or more vacuum holes 426 may be formed on the face of the door holder 420. A vacuum pipe (not shown) is connected to the vacuum hole 426(s) to establish a connection to a vacuum pump (not shown) and allow a vacuum to be applied to the door 140 surface adjacent the vacuum holes.

An inflow hole 146 may be provided through the door 140 to enable the nitrogen or other purge gas injected from the injection port 522 to flow into the FOUP 100. The inflow hole 146 is positioned to align and cooperate with the injection port 522 when the door 140 is docked to the door holder 420.

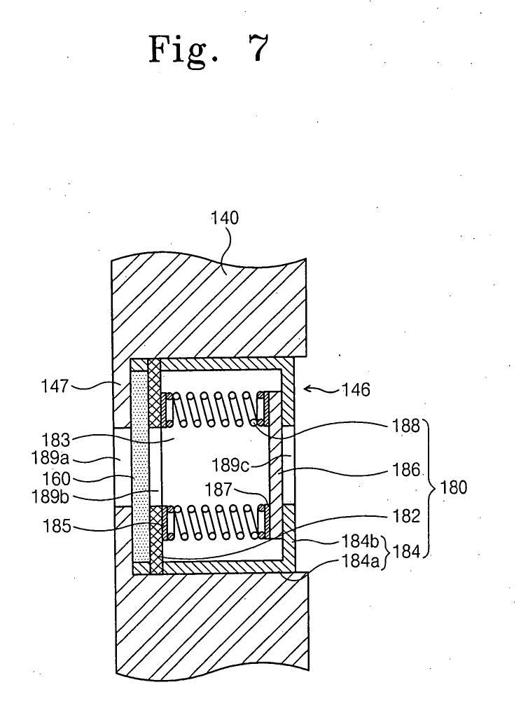

As illustrated in FIG. 7, a filter 160 and an inflow hole close/open part 180 may be arranged within the respective inflow holes 146. The filter 160 will tend to reduce or prevent particles from flowing into the FOUP 100 through the inflow hole 146. The inflow hole close/open part 180 opens and closes a passage for the gas through the FOUP door 140. The inflow hole open/close part 180 opens the inflow hole 146 while the gas is injected and closes the inflow hole 146 when the gas injection has been completed.

The inflow hole 146 may be circular with a protrusion 147 formed at the rear end of the inflow hole 146. The inflow hole open/close part 180 may include a fixture 184, a protrusion plate 182, an isolation plate 186 and an elastic body or spring element 188. The protrusion plate 182 may be a circular plate having a central through-hole 189b arranged to cooperate with the protrusion 147. The fixture 184 may be generally cylindrical and include a side plate 184a and an outer or upper plate 184b. The side plate 184a will generally adhere and conform closely to a sidewall of the inflow hole 146 and extend from the edge of the protrusion plate 182 to the front end of the inflow hole 146. The upper plate 184b has a through-hole 189c formed at its center. These through-holes 189a, 189b and 189c cooperate to provide a passage for the gas into the container and may have the same size general and shape.

The isolation plate 186 will typically be configured to open/close the through-hole 189c and will typically be disposed in a space 183 within the fixture 184 and the protrusion plate 182. The isolation plate 186 may be a circular plate that is both wider than the through-hole 189c and narrower than the internal space defined by the side plate 184a. The elastic body or spring element 188 applies a force to the isolation plate 186 that will tend to force it against an inner surface of upper plate 184b. One end of the elastic body 188 may be coupled to a fix pin or other retainer 187 installed on the rear surface of the isolation plate 186 with the other end being coupled to a fix pin or other retainer 185 provide on an inner surface of the protrusion plate 182. Alternatively, the elastic body may be allowed to “float” within the space 183. The elastic body 188 may include a series of springs disposed at regular intervals around the periphery of the isolation plate 186 or may be a single spring or elastomeric element. When the isolation plate 186 is seated against the upper plate 184b of the fixture 184, the elastic body 188 should be in an equilibrium or slightly compressed state to maintain the closed position.

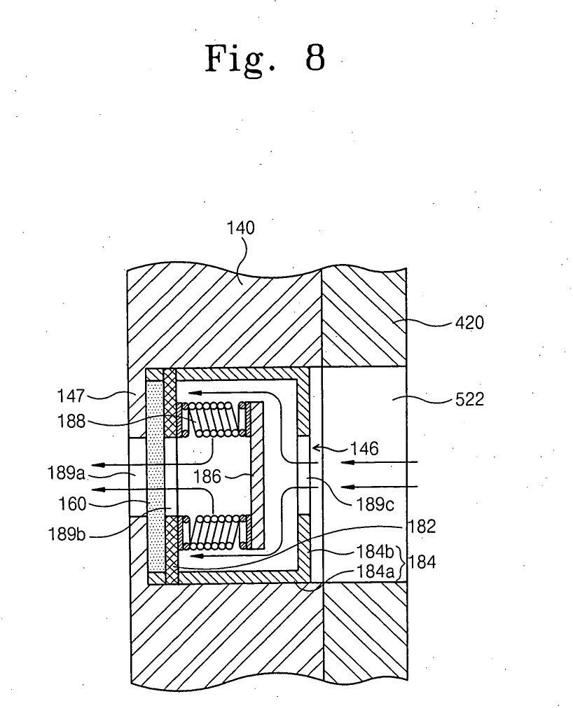

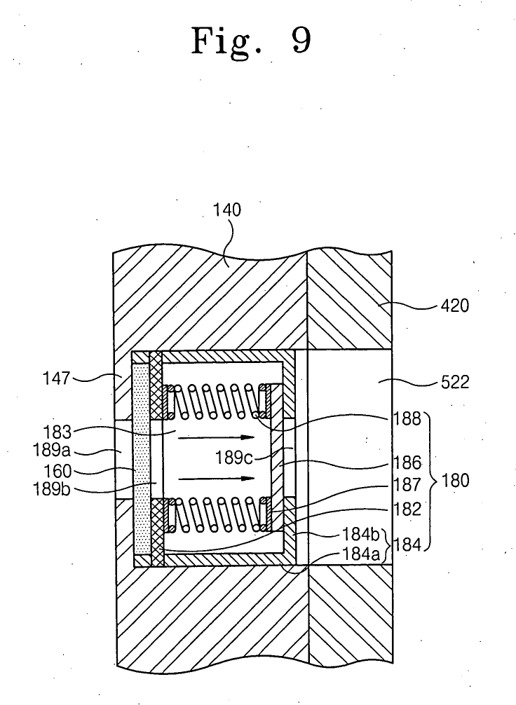

The open and closed states of the inflow hole 146 of the door 140 are illustrated in FIG. 8 and FIG. 9, respectively. As illustrated in FIG. 8, when the gas is supplied at a sufficient pressure above the pressure within the container from the injection port 522, the elastic body 188 will be compressed and the isolation plate 186 will move backward from the upper plate 184b of the fixture 184. The pressurized gas will then flow into the inflow hole 146 through the opening formed between the isolation plate 186 and the upper plate 184b of the fixture 184. Afterwards, the gas will flow along the through-hole 189b of the protrusion plate 182, the filter 160 and the through-hole 189a of the protrusion 147. When the applied pressure of the gas is reduced, the isolation plate 186 will tend to move forward as a result of the force applied by the spring 188. When the pressure differential drops below a certain level, the isolation plate will again be seated against the upper plate 184b to close the gas passage through the inflow hole 146, as shown in FIG. 9.

Before the atmosphere inside the FOUP 100 is converted to nitrogen or other purge gas, the fluid originally in the FOUP 100 (typically the air in the FOUP 100 and oxygen, water or other compound(s) carried by a wafer) must be removed. The fluid in the FOUP 100 may be removed through the exhaust part 540 provided in the door holder 420. For this, an outflow hole 148 in formed at the door 140. The outflow hole 148 is disposed to align with the exhaust port 424 when the door 140 is docked with the door holder 420.

A filter 170 and an outflow hole open/close part 190 may be inserted into the outflow hole 148. The filter 170 prevents contaminants from flowing into the FOUP 100 through the exhaust part 540. The outflow hole open/close part 190 opens and closes a passage through the outflow hole 148 through which the fluid remaining in the FOUP 100 may be exhausted or vented. The outflow hole open/close part 190 opens the outflow hole 148 while the fluid in the FOUP 100 is being exhausted, and then closes the outflow hole 148 to maintain the ambient of nitrogen or other purge gas(es) that were introduced into the FOUP 100 through the inflow hole.

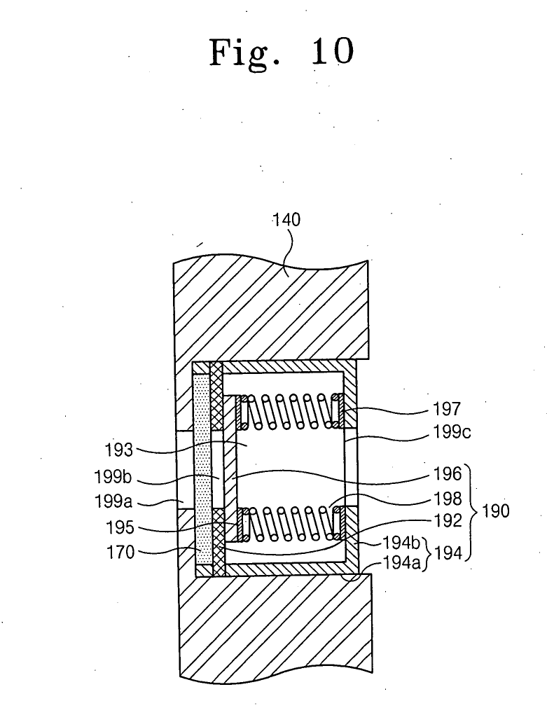

As illustrated in FIG. 10, the outflow hole 148 may have the same general configuration as the inflow hole 146. The shape and position of the filter 170 inserted into the outflow hole 148 may be identical to those of the filter 160 inserted into the inflow hole 146. Further, the outflow hole open/close part 190 may have the same shape of fixture 194, protrusion plate 192, isolation plate 196 and elastic body 198 as those described above for the inflow hole open/close part 180. The connecting positions of the isolation plate 196 and the elastic body 198 will, however, be reversed from that of the isolation plate 186 and the elastic body 188. The isolation plate 196 is disposed to face the protrusion plate 192, as shown in FIG. 9. One end of the elastic body 198 may be connected to a fix pin or other retainer 195 installed at the front edge of the isolation plate 196, with the other end being similarly connected to a fix pin or other retainer 195 installed at the upper plate 194b of the fixture 194.

When the pump 548 of the exhaust part 540 is activated and reduced the pressure applied to the backside of the isolation plate 196 below that of the interior of the container 120, the isolation plate will tend to move backward as a result of this pressure differential and be spaced apart from the protrusion plate 192 as the elastic body 198 is compressed. The fluid in the FOUP 100 will then be exhausted, vented or otherwise removed through a space 193 made between the protrusion plate 192 and the isolation plate 196 and a through-hole 199c formed at the upper plate 194b of the fixture 194. When the operation of the pump 548 is terminated, the isolation plate 196 will move forward as a result of the elastic force of the elastic body 198 to reseat against the protrusion plate 192 and close the fluid passage through the inflow hole 148.

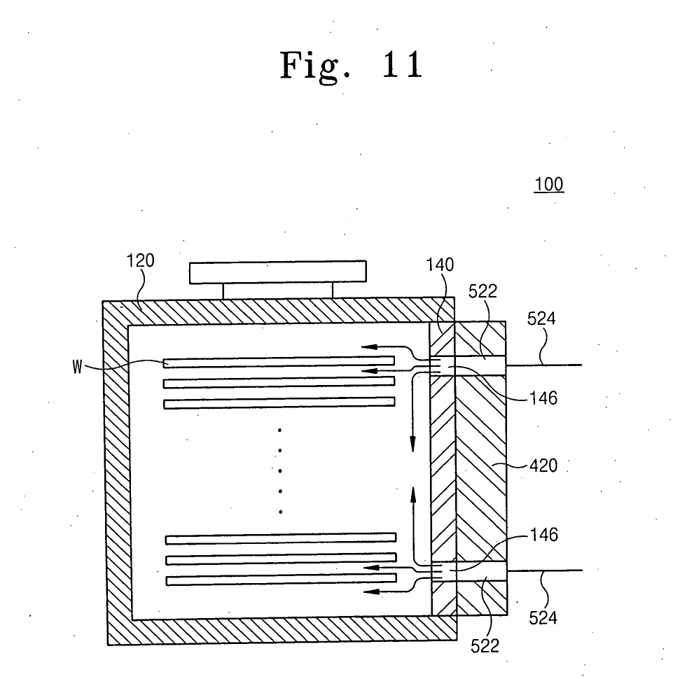

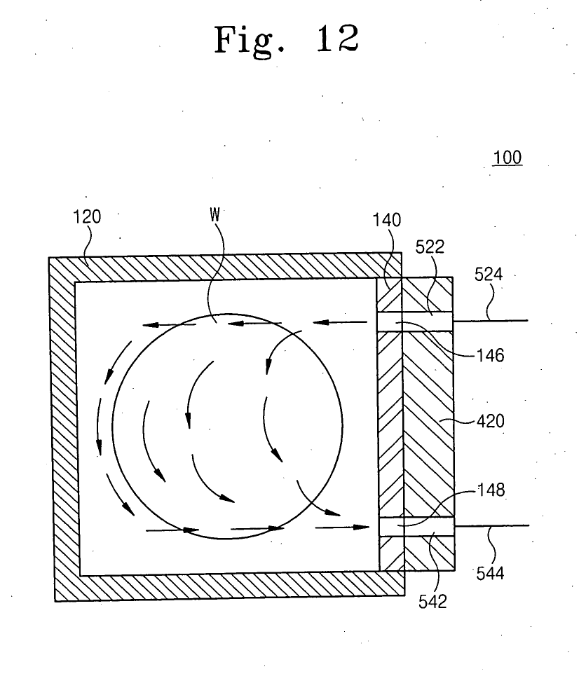

As illustrated in FIG. 11 and FIG. 12, the injection part 520 is disposed at the door holder 420. The nitrogen or other purge gas injected from the injection part 520 may be injected into the FOUP 100 through the inflow hole 146 formed at the door 140 in a direction parallel with the primary wafer surfaces. Thus, water and oxygen attached to surfaces of wafers may be removed more rapidly and completely.

According to an exemplary embodiment of the present invention, the interior of the FOUP 100 may be converted to a nitrogen-ambient almost immediately after loading the wafers into the FOUP. This is because a native oxide layer may be formed on a wafer when the atmosphere within the FOUP 100 is not converted to a nitrogen or other inert gas ambient while transporting or storing the FOUP before the next processing step.

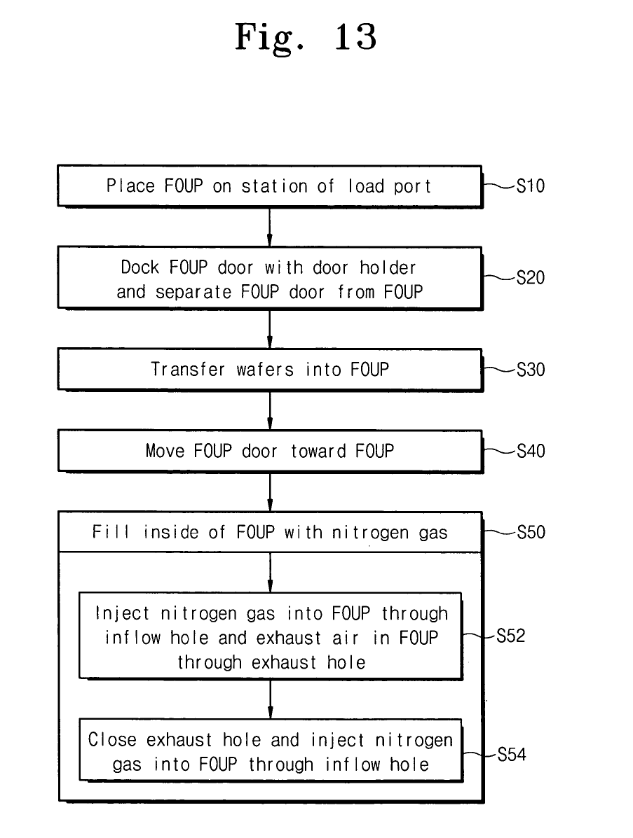

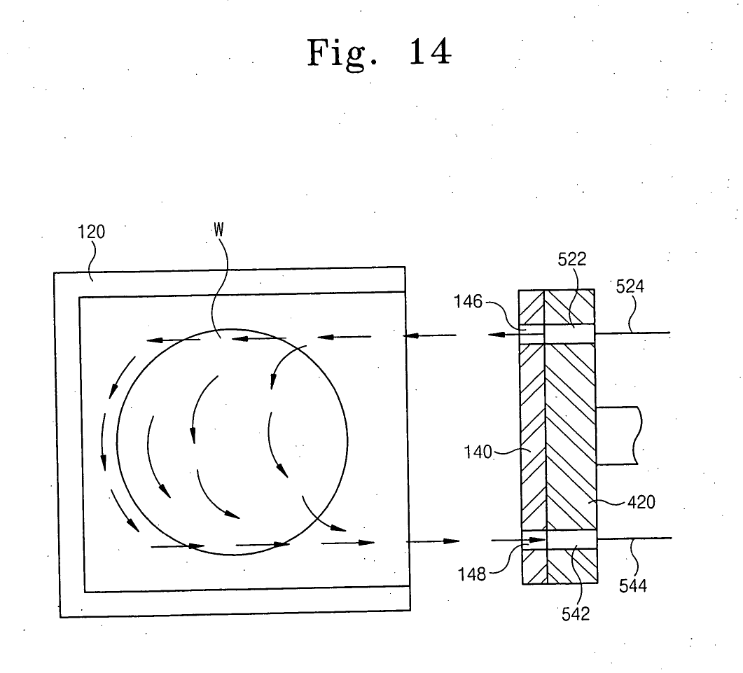

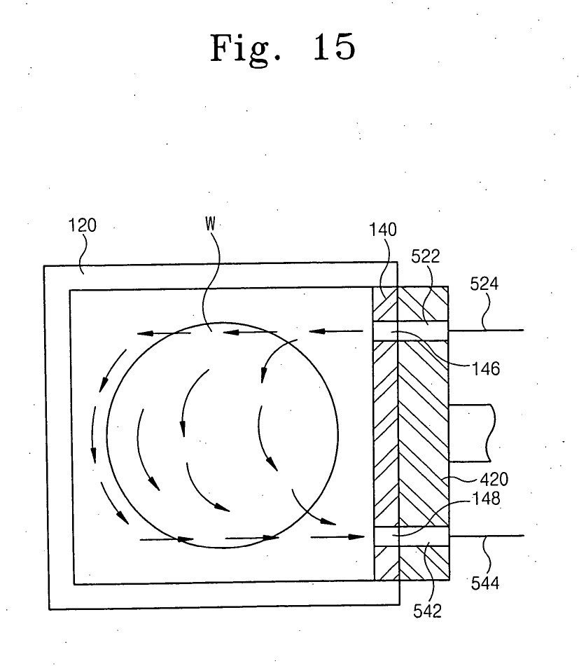

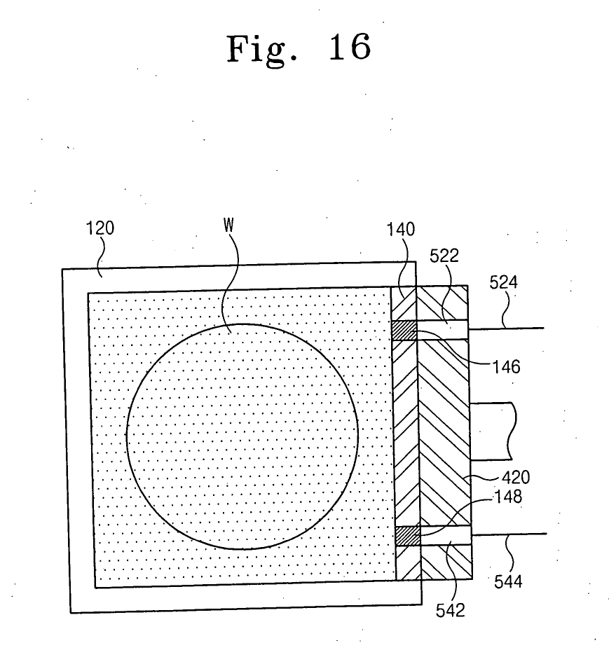

FIG. 13 is a flowchart of an exemplary substrate treating method according to an embodiment of the present invention, and FIGS. 14-16 are cross-sectional views showing the steps of filling the inside of the FOUP with nitrogen or other purge gas. An empty FOUP 100 is placed on a stage 260 of a load port, and the door 140 is docked to a door holder 420 (step S10). The door 140 is opened, and the door holder 420 and the door 140 are moved out of the way to allow access to the interior of the body 120 of the FOUP 100 (step S20). Processed wafers are then loaded into the FOUP using a transfer robot 660 or other device (step S30). When the wafers are loaded in the FOUP 100, the door holder 420 is activated to return the door 140 to the FOUP 100 (step S40). While the door 140 moves, nitrogen or another purge gas is injected and the pump 548 operates, as shown in FIG. 14. An inflow hole 146 formed at a door 140 is opened by an increased external gas pressure, and an outflow hole 148 formed at the door 140 is opened by a reduced external (vacuum) pressure. The nitrogen gas may be injected into the FOUP 100 in a direction parallel to the wafer surfaces to aid in removing attached particles and/or water. The fluid remaining in the FOUP 100 is exhausted through the outflow hole 148 and an exhaust pipe 540 (step S54). When the door 140 is connected to the FOUP 100 to close the FOUP, the operation of the pump 548 may be stopped and the outflow hole 148 may be closed. Alternatively, after the door 140 is closed, additional nitrogen gas may be injected into the FOUP 100 and the fluid in the FOUP may be exhausted for a predetermined time. As shown in FIG. 16, the inside of the FOUP 100 is converted to a nitrogen or other generally inert gas ambient by gas supplied through injection port 522 (step S54). After a predetermined period of time, the gas injection may be stopped and the inflow hole 146 formed at the door 140 may be closed.

While the exemplary embodiment has been described with the nitrogen gas being injected while the door 140 moves toward the FOUP 100, the nitrogen gas may be injected after the door 140 is connected to the FOUP 100.

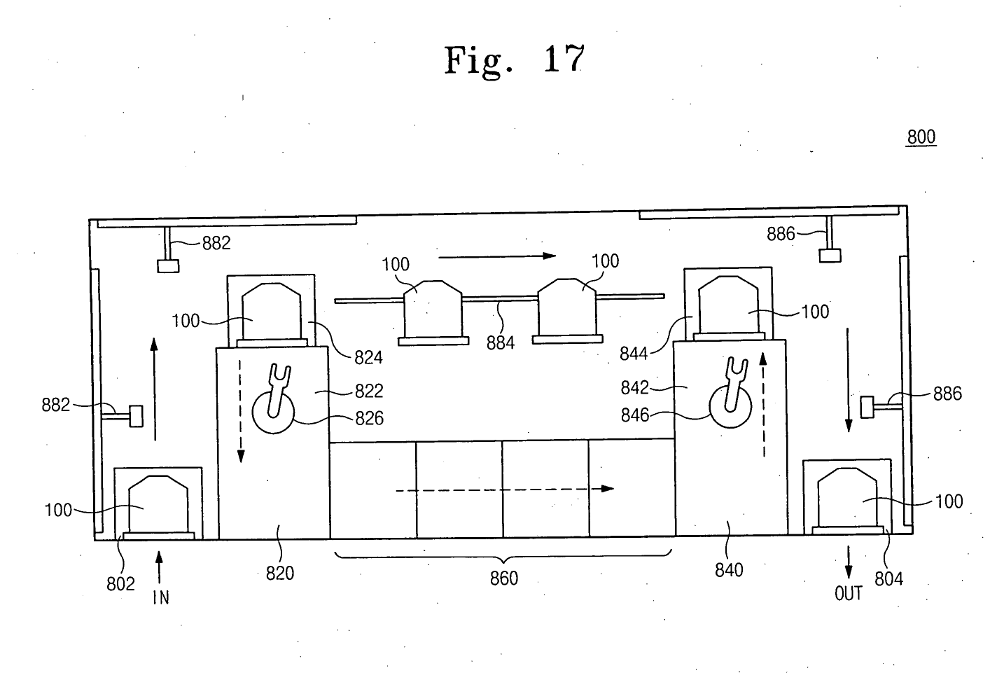

In FIG. 17, a solid-line arrow indicates a transportation path of the FOUP 100, and a dotted-line arrow indicates a transfer path of a wafer. In a clean apparatus, a cleaning process may be carried out in a series of baths 860 are disposed in a line. An EFEM 820 is disposed at one side of the respective baths 860, and another EFEM 840 is disposed at the other side thereof. To make the inside of the FOUP 100 loading completely cleaned wafers therein nitrogen-ambient, the EFEM 840 disposed at the other side of the respective baths 860 may include the purge part 500 detailed above or an equivalent structure.

After being carried into the cleaning apparatus 800, the wafer-loading FOUP 100 is loaded to the load port 824 of the EFEM 820 disposed at the entry side of the baths 860 by means of a transfer part 882. By means of a transfer robot, the wafers in the FOUP 100 are then transferred to the bath 860 and a vacant FOUP 100 is transported to the load port 844 of the EFEM 840 disposed at the exit side of the baths 860. The wafers are cleaned in the baths 860. The cleaned wafers are transferred into the FOUP 100 placed at the load port 844 of the EFEM 840. When the wafers are loaded in the FOUP 100, the nitrogen gas is injected to make the inside of the FOUP 100 nitrogen-ambient. The wafers are then carried out from the semiconductor manufacturing apparatus by means of a transfer part 866.

While exemplary embodiments of the present invention have been shown and described in detail, the foregoing description is illustrative only and should not be interpreted as unduly limiting the scope of the invention. It is therefore understood that various modifications and substitutes may be made without departing from the scope of the invention.

1. A wafer transfer container comprising:
a container arranged and configured to hold semiconductor wafers;
a door arranged and configured for sealing the container to form a closed container;
an inlet for introducing a purge gas into the container;
an outlet for removing gas from the container.

2. A wafer transfer container according to claim 1, further comprising:
an alignment structure provided on the container for aligning the container with a transfer station; and
an alignment structure provided on the door for aligning the door with a door holder.

3. A wafer transfer container according to claim 2, further comprising:
a docking structure for securing the door to the door holder.

4. A wafer transfer container according to claim 3, wherein:
the inlet is opened by a pressure differential between a higher purge gas inlet pressure and a lower inner pressure to allow purge gas to flow into the container; and
the outlet is opened by a pressure differential between a higher inner pressure and a lower exhaust pressure to allow fluid to be removed from the container.

5. A wafer transfer container according to claim 4, further comprising:
a first filter element arranged within the inlet; and
a second filter element arranged within the outlet.

6. A wafer transfer container according to claim 4, wherein:
the inlet is provided through the door; and
the outlet is provided through the door and offset from the inlet.

7. A wafer transfer apparatus comprising:
a wafer transfer container according to claim 1;
a load port arranged and configured to receive and align the wafer transfer container relative to a housing;
a door holder arranged and configured to be aligned with and secured to the door;
a door opener arranged and configured for repositioning the door holder and thereby removing the door and exposing an interior of the container;
an injection assembly arranged and configured for selectively applying a pressurized purge gas to the inlet; and
an exhaust assembly arranged and configured for selectively applying a partial vacuum to the outlet.

8. A wafer transfer apparatus according to claim 7, further comprising:
a wafer transfer mechanism provided within the housing arranged and configured for the selective insertion into the container and removal of wafers from the container while the door is removed.

9. A wafer transfer apparatus according to claim 7, further comprising:
a docking structure for securing the door to the door holder, the docking structure including at least one device selected from a group consisting of vacuum ports, cams, sliding latches and rotating latches.

10. A wafer transfer apparatus according to claim 7, wherein:
the injection assembly includes a mass flow controller arranged between a gas supply and the inlet.

11. A wafer transfer apparatus according to claim 7, further comprising:
an injection port cooperation with the inlet for injecting the gas in a direction generally parallel to a major surface of semiconductor wafers loaded in the container.

12. A wafer transfer apparatus according to claim 7, wherein:
the inlet includes a valve assembly, the valve assembly including
an outer plate having an opening provided therein;
an isolation plate arranged and configured for sealing the opening; and
a resilient member arranged and configured to urge the isolation plate against the outer plate.

13. A wafer transfer apparatus according to claim 7, wherein:
the outlet includes a valve assembly, the valve assembly including
an inner plate having an opening provided therein;
an isolation plate arranged and configured for sealing the opening; and
a resilient member arranged and configured to urge the isolation plate against the inner plate.

14. A wafer transfer apparatus according to claim 12, further comprising:
a first plurality of inlets arranged in a first pattern.

15. A wafer transfer apparatus according to claim 7, wherein:
the purge gas includes at least one gas is selected from a group consisting of nitrogen, helium, neon, argon, krypton, xenon and dry air.

16. A method of transferring a wafer comprising:
positioning a transfer container at a load port;
removing a door to open the transfer container;
inserting a wafer into the transfer container under a first atmosphere;
modifying the first atmosphere to form a second atmosphere, the second atmosphere being inert relative to the first atmosphere;
closing the transfer container; and
removing the transfer container from the load port while maintaining the second atmosphere within the transfer container.

17. A method of transferring a wafer according to claim 16, further comprising:
closing the container before modifying the first atmosphere.

18. A method of transferring a wafer according to claim 16, wherein:
modifying the first atmosphere includes
evacuating a portion of the first atmosphere through an outlet; and
introducing an inert gas into the container through an inlet.

19. A method of transferring a wafer according to claim 16, wherein:
modifying the first atmosphere includes
introducing an inert gas into the container through an inlet; and
venting fluid within the container through an outlet.

20. A method of transferring a wafer according to claim 16, wherein:
positioning a transfer container at a load port includes
engaging corresponding alignment structures provided on the load port and the transfer container; and
engaging a docking mechanism to establish a secure removable attachment between the door and a door holder, whereby an injection apparatus provided in the door holder is fluidly coupled to an inlet provided on the door and an exhaust apparatus provided in the door holder is fluidly coupled to an outlet provided on the door;
removing the door includes activating a mechanism to alter the positioning of the door holder to expose an interior of the transfer container; and
modifying the first atmosphere to form a second atmosphere includes
injecting a purge gas from the injection apparatus through the inlet and into the interior of the transfer container and
removing fluid from the interior of the transfer container through the outlet and through the exhaust apparatus.
